(19) United States
(12) Patent Application Publication
(10) Pub. No.: US 2012/0174007 A1
(43) Pub. Date: Jul. 5, 2012

(54) MOBILE TERMINAL AND METHOD OF GROUPING APPLICATIONS THEREOF

(76) Inventors: Seungwon LEE, Seoul (KR); Jungsu Lee, Seoul (KR); Seheon Choi, Seoul (KR); Jinwook Choi, Gyeonggi-Do (KR); Minkyung Cho, Seoul (KR); Seungcheon Baek, Seoul (KR); Kyunghwan Kim, Gyeonggi-Do (KR)

(21) Appl. No.: 13/340,277

(22) Filed: Dec. 29, 2011

(30) Foreign Application Priority Data
Dec. 31, 2010 (KR) 10-2010-0140673

(51) Int. Cl. G06F 3/048

(52) U.S. Cl. 715/765

(57) ABSTRACT

The present disclosure relates to a mobile terminal capable of determining a category of an application based on a context type related to the application executable in the mobile terminal and an operation control method thereof, thereby allowing a user to intuitively and conveniently manage applications executable in the mobile terminal. To this end, a mobile terminal according to an embodiment of the present invention may include a storage unit configured to store an application and an object set to execute the application; a display unit configured to display the object on a screen; and a controller configured to acquire a context type of the application when the object displayed on the screen is selected, and determine a category of the application based on the acquired context type.

### RELATED APPLICATION

Pursuant to 35 U.S.C. §119(a), this application claims the benefit of earlier filing date and right of priority to Korean Application No. 10-2010-0140673, filed on Dec. 31, 2010, the contents of which is incorporated by reference herein in its entirety.

### BACKGROUND OF THE INVENTION

1. Field of the Invention

The present disclosure relates to a mobile terminal and an operation control method thereof, and more particularly, to a mobile terminal having a function of executing an application and a method of grouping applications thereof.

2. Description of the Related Art

Terminals can be classified into a mobile terminal and a stationary terminal based on its mobility. Furthermore, the mobile terminal can be further classified into a handheld terminal and a vehicle mount terminal based on whether or not it can be directly carried by a user.

In recent years, as a mobile terminal provides complicated and various functions, the convenience of a user interface (UI) including a function of managing an application or the like has been required to take into consideration.

### SUMMARY OF THE INVENTION

A technical task of the present disclosure is to provide a mobile terminal capable of determining a category of an application based on a context type related to the application executable in the mobile terminal and an operation control method thereof, thereby allowing a user to intuitively and conveniently manage applications executable in the mobile terminal.

In order to accomplish the foregoing task, a mobile terminal associated with an example of the present invention may include a storage unit configured to store an application and an object set to execute the application; a display unit configured to display the object on a screen; and a controller configured to acquire a context type of the application when the object displayed on the screen is selected, and determine a category of the application based on the acquired context type.

In an embodiment, the mobile terminal may be characterized in that the controller selects the object displayed on the screen when the application is installed or executed.

Furthermore, in an embodiment, the mobile terminal may further include an input unit configured to sense an input for selecting the object displayed on the screen.

Furthermore, in an embodiment, the mobile terminal may be characterized in that the controller controls the display unit to display a context type of the application on the screen when the object displayed on the screen is selected.

Furthermore, in an embodiment, the mobile terminal may be characterized in that the controller controls the display unit to display at least one object related to a context type of the application on the screen when the object displayed on the screen is selected.

Furthermore, in an embodiment, the mobile terminal may be characterized in that the controller acquires the context type based on information referred to when the application accesses data stored in the storage unit.

Furthermore, in an embodiment, the mobile terminal may be characterized in that the information comprises the identification information of an intent or provider generated when executing the application.

Furthermore, in an embodiment, the mobile terminal may be characterized in that the information is detected from a script generated when installing the application.

Furthermore, in an embodiment, the mobile terminal may be characterized in that the controller acquires the context type from an application providing server.

Furthermore, in an embodiment, the mobile terminal may further include an input unit configured to sense an input for selecting the context type.

Furthermore, in an embodiment, the mobile terminal may be characterized in that the controller moves the object to a group object corresponding to the determined category.

Furthermore, in an embodiment, the mobile terminal may be characterized in that the controller generates a group object corresponding to the determined category, and moves the object to the generated group object.

Furthermore, in an embodiment, the mobile terminal may be characterized in that the context type comprises data accessed or a module type used while executing the application.

Furthermore, in an embodiment, the mobile terminal may be characterized in that the category is a name of the context type.

On the other hand, in order to accomplish the foregoing task, an operation control method of a mobile terminal associated with an example of the present invention may include displaying an object set to execute an application on a screen; selecting an object displayed on the screen; and acquiring a context type of the application, and determining a category of the application based on the acquired context type.

In an embodiment, the operation control method of a mobile terminal may further include sensing an input for selecting the object displayed on the screen.

Furthermore, in an embodiment, the method may be characterized in that said selecting step comprises displaying at least one object related to a context type of the application on the screen when the object displayed on the screen selected.

Furthermore, in an embodiment, the operation control method of a mobile terminal may further include moving the object to a group object corresponding to the determined category.

Furthermore, in an embodiment, the operation control method of a mobile terminal may further include generating a group object corresponding to the determined category; and moving the object to the generated group object.

Furthermore, in an embodiment, the method may be characterized in that the category is a name of the context type.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a block diagram illustrating a mobile terminal associated with an embodiment of the present invention;

FIG. 2A is a front perspective view illustrating an example of a mobile terminal associated with the present invention;

FIG. 2B is a rear perspective view illustrating a mobile terminal illustrated in FIG. 2A;

FIG. 3 is a flow chart illustrating the process of grouping applications in a mobile terminal according to an embodiment of the present invention;

FIGS. 4A through 4D are conceptual views illustrating the process of grouping applications according to an embodiment of the present invention;

FIGS. 5A through 5D are conceptual views for explaining the process of selecting an object illustrated in FIG. 3;

FIGS. 6A and 6B are views for explaining the process of acquiring a context type illustrated in FIG. 3; and

FIGS. 7A and 7B are conceptual views illustrating the process of manually grouping applications according to an embodiment of the present invention.

### DETAILED DESCRIPTION OF THE INVENTION

Hereinafter, a mobile terminal associated with the embodiments of the present invention will be described in more detail with reference to the accompanying drawings. A suffix “module” or “unit” used for constituent elements disclosed in the following description is merely intended for easy description of the specification, and the suffix itself does not give any special meaning or function.

A mobile terminal disclosed herein may include a portable phone, a smart phone, a laptop computer, a digital broadcast terminal, a personal digital assistant (PDA), a portable multimedia player (PMP), a navigation, and the like. However, it would be easily understood by those skilled in the art that a configuration according to the following description may be applicable to a stationary terminal such as a digital TV, a desktop computer, and the like, excluding constituent elements particularly configured for mobile purposes.

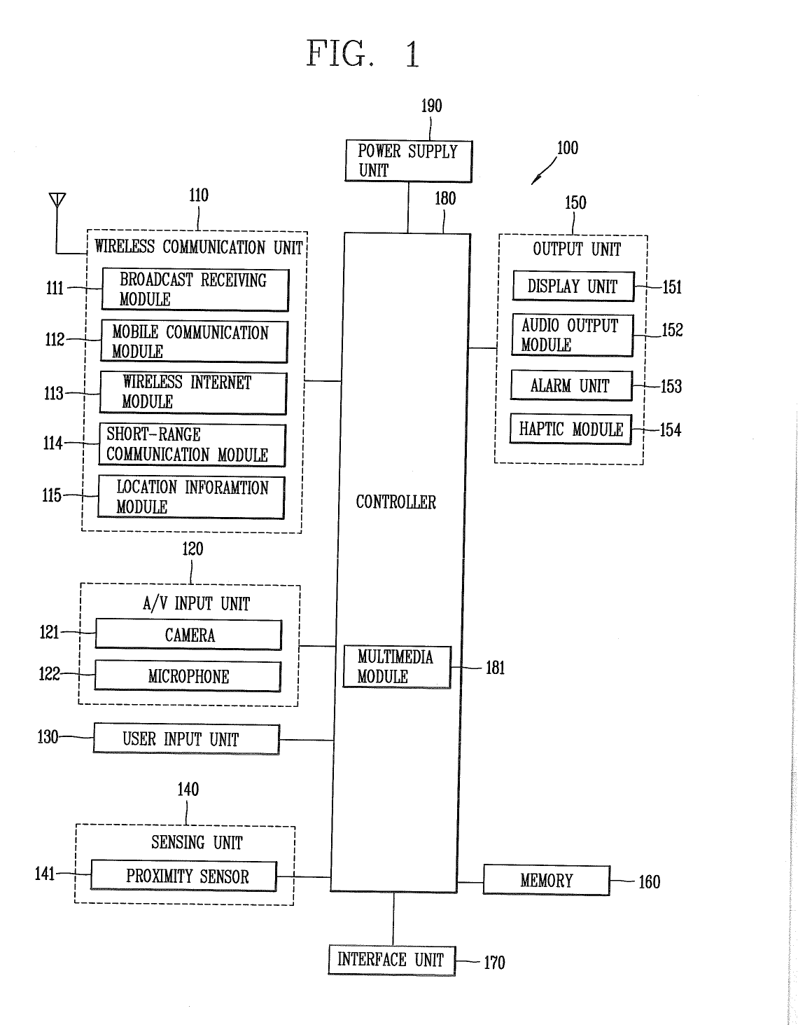

FIG. 1 is a block diagram illustrating a mobile terminal associated with an embodiment of the present invention.

The mobile terminal 100 may include a wireless communication unit 110, an audio/video (A/V) input unit 120, a user input unit 130, a sensing unit 140, an output unit 150, a memory 160, an interface unit 170, a controller 180, a power supply unit 190, and the like. However, the constituent elements as illustrated in FIG. 1 are not necessarily required, and the mobile terminal may be implemented with greater or less number of elements than those illustrated elements.

Hereinafter, the constituent elements will be described in sequence.

The wireless communication unit 110 typically includes one or more elements allowing radio communication between the mobile terminal 100 and a wireless communication system, or allowing radio communication between radio communication the mobile terminal 100 and a network in which the mobile terminal 100 is located. For example, the wireless communication unit 110 may include a broadcast receiving module 111, a mobile communication module 112, a wireless Internet module 113, a short-range communication module 114, a location information module 115, and the like.

The broadcast receiving module 111 receives broadcast signals and/or broadcast associated information from an external broadcast management server through a broadcast channel.

The broadcast channel may include a satellite channel and/or a terrestrial channel. The broadcast management server may mean a server that generates and transmits a broadcast signal and/or broadcast associated information or a server that receives a previously generated broadcast signal and/or broadcast associated information and transmits to the mobile terminal 100. The broadcast signal may include a TV broadcast signal, a radio broadcast signal and a data broadcast signal as well as a broadcast signal in a form that a data broadcast signal is coupled to the TV or radio broadcast signal.

The broadcast associated information may mean information regarding a broadcast channel, a broadcast program, a broadcast service provider, and the like. The broadcast associated information may also be provided through a mobile communication network, and in this case, the broadcast associated information may be received by the mobile communication module 112.

The broadcast associated information may exist in various forms. For example, it may exist in the form of an electronic program guide (EPG) of digital multimedia broadcasting (DMB), electronic service guide (ESG) of digital video broadcast-handheld (DVB-H), and the like.

The broadcast receiving module 111 may receive a broadcast signal using various types of broadcast systems. In particular, the broadcast receiving module 111 may receive a digital broadcast signal using a digital broadcast system such as digital multimedia broadcasting-terrestrial (DMB-T), digital multimedia broadcasting-satellite (DMB-S), media forward link only (MediaFLO), digital video broadcast-handheld (DVB-H), integrated services digital broadcast-terrestrial (ISDB-T), and the like. The broadcast receiving module 111 is, of course, configured to be suitable for every broadcast system that provides a broadcast signal as well as the above-mentioned digital broadcast systems.

The broadcast signal and/or broadcast-associated information received through the broadcast receiving module 111 may be stored in the memory 160.

The mobile communication module 112 transmits and/or receives a radio signal to and/or from at least one of a base station, an external terminal and a server over a mobile communication network. Here, the radio signal may include a voice call signal, a video call signal and/or various types of data according to text and/or multimedia message transmission and/or reception.

The wireless Internet module 113 means a module for supporting wireless Internet access. The wireless Internet module 113 may be built-in or externally installed to the mobile terminal 100. Here, it may be used a wireless Internet access technique including a WLAN (Wireless LAN), Wi-Fi, Wibro (Wireless Broadband), Wimax (World Interoperability for Microwave Access), HSDPA (High Speed Downlink Packet Access), and the like.

The short-range communication module 114 is a module for supporting a short-range communication. Here, it may be used a short-range communication technology including Bluetooth, Radio Frequency IDentification (RFID), Infrared Data Association (IrDA), Ultra WideBand (UWB), ZigBee, and the like.

The location information module 115 is a module for checking or acquiring a location of the mobile terminal, and there is a GPS module as a representative example.

Referring to FIG. 1, the A/V (audio/video) input unit 120 receives an audio or video signal, and the A/V (audio/video) input unit 120 may include a camera 121 and a microphone 122. The camera 121 processes a image frame, such as still picture or video, obtained by an image sensor in a video phone call or image capturing mode. The processed image frame may be displayed on a display unit 151.

The image frames processed by the camera 121 may be stored in the memory 160 or transmitted to an external device through the wireless communication unit 110. Two or more cameras 121 may be provided according to the use environment of the mobile terminal.

The microphone 122 receives an external audio signal through a microphone in a phone call mode, a recording mode, a voice recognition mode, and the like, and processes the audio signal into electrical voice data. The processed voice data may be converted and outputted into a format that is transmittable to a mobile communication base station through the mobile communication module 112 in the phone call mode. The microphone 122 may implement various types of noise canceling algorithms to cancel noise generated in a procedure of receiving the external audio signal.

The user input unit 130 may generate input data to control an operation of the terminal. The user input unit 130 may be configured by including a keypad, a dome switch, a touch pad (pressure/capacitance), a jog wheel, a jog switch, and the like.

The sensing unit 140 detects a current status of the mobile terminal 100 such as an opened or closed state of the mobile terminal 100, a location of the mobile terminal 100, an orientation of the mobile terminal 100, and the like, and generates a sensing signal for controlling the operation of the mobile terminal 100. For example, when the mobile terminal 100 is a slide phone type, it may sense an opened or closed state of the slide phone. Furthermore, the sensing unit 140 takes charge of a sensing function associated with whether or not power is supplied from the power supply unit 190, or whether or not an external device is coupled to the interface unit 170. On the other hand, the sensing unit 140 may include a proximity sensor 141.

The output unit 150 is configured to provide an output for audio signal, video signal, or alarm signal, and the output unit 150 may include the display unit 151, an audio output module 152, an alarm unit 153, a haptic module 154, and the like.

The display unit 151 may display(output) information processed in the mobile terminal 100. For example, when the mobile terminal 100 is in a phone call mode, the display unit 151 may display a User Interface (UI) or a Graphic User Interface (GUI) associated with a call. When the mobile terminal 100 is in a video call mode or image capturing mode, the display unit 151 may display a captured image and/or received image, a UI or GUI.

The display unit 151 may include at least one of a Liquid Crystal Display (LCD), a Thin Film Transistor-LCD (TFT-LCD), an Organic Light Emitting Diode (OLED) display, a flexible display, a three-dimensional (3D) display.

Some of those displays may be configured with a transparent or optical transparent type to allow viewing of the exterior through the display unit, which may be called transparent displays. An example of the typical transparent displays may include a transparent LCD (TOLED), and the like. Under this configuration, a user can view an object positioned at a rear side of a terminal body through a region occupied by the display unit 151 of the terminal body.

The display unit 151 may be implemented in two or more in number according to an implementation type of the portable terminal 100. For instance, a plurality of the display units 151 may be arranged on one surface to be spaced apart from or integrated with each other, or may be arranged on different surfaces.

Here, when the display unit 151 and a touch sensitive sensor (hereinafter, referred to as a “touch sensor”) have an interlayer structure (hereinafter, referred to as a “touch screen”), the display unit 151 may be used as an input device rather than an output device. The touch sensor may be implemented as a touch film, a touch sheet, a touch pad, and the like.

The touch sensor may be configured to convert changes of a pressure applied to a specific part of the display unit 151, or a capacitance occurring from a specific part of the display unit 151, into electric input signals. Also, the touch sensor may be configured to sense not only a touched position and a touched area, but also a touch pressure.

When touch inputs are sensed by the touch sensors, the corresponding signals are transmitted to a touch controller. The touch controller processes the received signals, and then transmits corresponding data to the controller 180. Accordingly, the controller 180 may sense which region of the display unit 151 has been touched.

Referring to FIG. 1, a proximity sensor 141 may be arranged at an inner region of the portable terminal 100 covered by the touch screen, or near the touch screen. The proximity sensor indicates a sensor to sense presence or absence of an object approaching to a surface to be sensed, or an object disposed near a surface to be sensed, by using an electromagnetic field or infrared rays without a mechanical contact. The proximity sensor has a longer lifespan and a more enhanced utility than a contact sensor.

The proximity sensor may include an optical transmission type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and so on. When the touch screen is implemented as a capacitance type, proximity of a pointer to the touch screen is sensed by changes of an electromagnetic field. In this case, the touch screen (touch sensor) may be categorized into a proximity sensor.

Hereinafter, for the sake of convenience of brief explanation, a status that the pointer is positioned to be proximate onto the touch screen without contact will be referred to as “proximity touch”, whereas a status that the pointer substantially comes in contact with the touch screen will be referred to as “contact touch”. For the position corresponding to the proximity touch of the pointer on the touch screen, such position corresponds to a position where the pointer faces perpendicular to the touch screen upon the proximity touch of the pointer.

The proximity sensor senses proximity touch, and proximity touch patterns (e.g., proximity touch distance, proximity touch direction, proximity touch speed, proximity touch time, proximity touch position, proximity touch moving status, etc.). Information relating to the sensed proximity touch and the sensed proximity touch patterns may be output onto the touch screen.

The audio output module 152 may output audio data received from the wireless communication unit 110 or stored in the memory 160, in a call-receiving mode, a call-placing mode, a recording mode, a voice recognition mode, a broadcast reception mode, and so on. The audio output module 152 may output audio signals relating to functions performed in the portable terminal 100 (e.g., sound alarming a call received or a message received, and so on). The audio output module 152 may include a receiver, a speaker, a buzzer, and so on.

The alarm 153 outputs signals notifying occurrence of events from the portable terminal 100. The events occurring from the portable terminal 100 may include call received, message received, key signal input, touch input, and so on. The alarm 153 may output not only video or audio signals, but also other types of signals such as signals notifying occurrence of events in a vibration manner. Since the video or audio signals can be output through the display unit 151 or the audio output unit 152, the display unit 151 and the audio output module 152 may be categorized into a part of the alarm 153.

The haptic module 154 generates various tactile effects which a user can feel. A representative example of the tactile effects generated by the haptic module 154 includes vibration. Vibration generated by the haptic module 154 may have a controllable intensity, a controllable pattern, and so on. For instance, different vibration may be output in a synthesized manner or in a sequential manner.

The haptic module 154 may generate various tactile effects, including not only vibration, but also arrangement of pins vertically moving with respect to a skin being touched, air injection force or air suction force through an injection hole or a suction hole, touch by a skin surface, presence or absence of contact with an electrode, effects by stimulus such as an electrostatic force, reproduction of cold or hot feeling using a heat absorbing device or a heat emitting device, and the like.

The haptic module 154 may be configured to transmit tactile effects through a user's direct contact, or a user's muscular sense using a finger or a hand. The haptic module 154 may be implemented in two or more in number according to the configuration of the portable terminal 100.

The memory 160 may store a program for processing and controlling the controller 180. Alternatively, the memory 160 may temporarily store input/output data (e.g., phonebook data, messages, audios, still images, videos, and the like). Also, the memory 160 may store data related to various patterns of vibrations and sounds outputted upon the touch input on the touch screen.

The memory 160 may be implemented using any type of suitable storage medium including a flash memory type, a hard disk type, a multimedia card micro type, a memory card type (e.g., SD or DX memory), Random Access Memory (RAM), Static Random Access Memory (SRAM), Read-Only Memory (ROM), Electrically Erasable Programmable Read-only Memory (EEPROM), Programmable Read-only Memory (PROM), magnetic memory, magnetic disk, optical disk, and the like. Also, the mobile terminal 100 may operate a web storage which performs the storage function of the memory 160 on the Internet.

The interface unit 170 may generally be implemented to interface the portable terminal with external devices. The interface unit 170 may allow a data reception from an external device, a power delivery to each component in the portable terminal 100, or a data transmission from the portable terminal 100 to an external device. The interface unit 170 may include, for example, wired/wireless headset ports, external charger ports, wired/wireless data ports, memory card ports, ports for coupling devices having an identification module, audio Input/Output (I/O) ports, video I/O ports, earphone ports, and the like.

The identification module may be configured as a chip for storing various information required to authenticate an authority to use the portable terminal 100, which may include a User Identity Module (UIM), a Subscriber Identity Module (SIM), and the like. Also, the device having the identification module (hereinafter, referred to as ‘identification device’) may be implemented in a type of smart card. Hence, the identification device can be coupled to the portable terminal 100 via a port.

The interface unit may serve as a path for power to be supplied from an external cradle to the portable terminal 100 when the portable terminal 100 is connected to the external cradle or as a path for transferring various command signals inputted from the cradle by a user to the portable terminal 100. Such various command signals or power inputted from the cradle may operate as signals for recognizing that the portable terminal 100 has accurately been mounted to the cradle.

The controller 180 typically controls the overall operations of the portable terminal 100. For example, the controller 180 performs the control and processing associated with telephony calls, data communications, video calls, and the like. The controller 180 may include a multimedia module 181 which provides multimedia playback. The multimedia module 181 may be configured as part of the controller 180 or as a separate component.

The controller 180 can perform a pattern recognition processing so as to recognize writing or drawing input on the touch screen as text or image.

The power supply unit 190 provides power required by various components under the control of the controller 180.

Various embodiments described herein may be implemented in a computer-readable medium using software, hardware, or any combination thereof.

For hardware implementation, it may be implemented by using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electrical units designed to perform the functions described herein. In some cases, such embodiments may be implemented in the controller 180 itself.

For software implementation, the embodiments such as procedures or functions may be implemented together with separate software modules that allow performing of at least one function or operation. Software codes can be implemented by a software application written in any suitable programming language. The software codes may be stored in the memory 160 and executed by the controller 180.

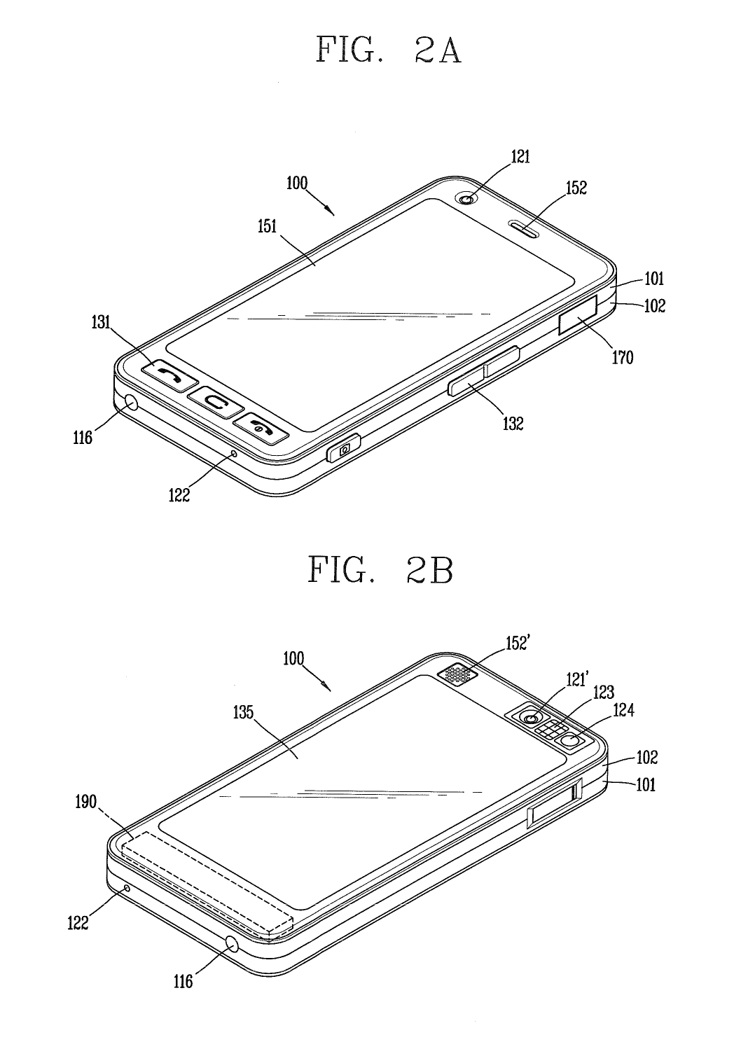

FIG. 2A is a front perspective view illustrating an example of a portable terminal or mobile terminal associated with the present invention.

The portable terminal 100 disclosed herein is provided with a bar-type terminal body. However, the present invention is not only limited to this type of terminal, but also applicable to various structures of terminals such as slide type, folder type, swivel type, swing type, and the like, in which two and more bodies are combined with each other in a relatively movable manner.

The terminal body includes a case (casing, housing, cover, etc.) forming an appearance of the terminal. In this embodiment, the case may be divided into a front case 101 and a rear case 102. At least one middle case may be additionally disposed between the front case 101 and the rear case 102.

The cases may be formed by injection-molding a synthetic resin or may be also formed of a metal material such as stainless steel (STS), titanium (Ti), or the like.

A display unit 151, an audio output module 152, a camera 121, a user input unit 130 (e.g., 131, 132), a microphone 122, an interface 170, and the like may be arranged on the terminal body, mainly on the front case 101.

The display unit 151 occupies a most portion of the front case 101. The audio output unit 152 and the camera 121 are disposed on a region adjacent to one of both ends of the display unit 151, and the user input unit 131 and the microphone 122 are disposed on a region adjacent to the other end thereof. The user interface 132 and the interface 170, and the like, may be disposed on a lateral surface of the front case 101 and the rear case 102.

The user input unit 130 is manipulated to receive a command for controlling the operation of the portable terminal 100, and may include a plurality of manipulation units 131, 132. The manipulation units 131, 132 may be commonly designated as a manipulating portion, and any method may be employed if it is a tactile manner allowing the user to perform manipulation with a tactile feeling.

The content inputted by the manipulation units 131, 132 may be set in various ways. For example, the first manipulation unit 131 may be used to receive a command, such as start, end, scroll, or the like, and the second manipulation unit 132 may be used to receive a command, such as controlling a volume level being outputted from the audio output unit 152, or switching it into a touch recognition mode of the display unit 151.

FIG. 2B is a rear perspective view illustrating a mobile terminal illustrated in FIG. 2A.

Referring to FIG. 2B, a camera 121′ may be additionally mounted on a rear surface of the terminal body, namely, the rear case 102. The camera 121′ has an image capturing direction, which is substantially opposite to the direction of the camera 121 (refer to FIG. 2A), and may have different pixels from those of the first video input unit 121.

For example, it is preferable that the camera 121 has a relatively small number of pixels enough not to cause a difficulty when the user captures his or her own face and sends it to the other party during a video call or the like, and the camera 121′ has a relatively large number of pixels since the user often captures a general object that is not sent immediately. The cameras 121, 121′ may be provided in the terminal body in a rotatable and popupable manner.

Furthermore, a flash 123 and a mirror 124 may be additionally disposed adjacent to the camera 121′. The flash 123 illuminates light toward an object when capturing the object with the camera 121′. The mirror 124 allows the user to look at his or her own face, or the like, in a reflected way when capturing himself or herself (in a self-portrait mode) by using the camera 121′.

Furthermore, an audio output unit 152′ may be additionally disposed on a rear surface of the terminal body. The audio output unit 152′ together with the audio output unit 152 (refer to FIG. 2A) can implement a stereo function, and it may be also used to implement a speaker phone mode during a phone call.

Furthermore, an antenna 116 for receiving broadcast signals may be additionally disposed on a lateral surface of the terminal body. The antenna 116 constituting part of a broadcast receiving module 111 (refer to FIG. 1) may be provided so as to be pulled out from the terminal body.

Furthermore, a power supply unit 190 for supplying power to the portable terminal 100 may be mounted on the terminal body. The power supply unit 190 may be configured so as to be incorporated in the terminal body, or directly detachable from the outside of the terminal body.

A touch pad 135 for detecting a touch may be additionally mounted on the rear case 102. The touch pad 135 may be also configured with an optical transmission type, similarly to the display unit 151. In this case, if the display unit 151 is configured to display visual information on both surfaces thereof, then visual information may be recognized through the touch pad 135. All the information displayed on the both surfaces may be controlled by the touch pad 135. Alternatively, a display is additionally mounted on the touch pad 135, and thus a touch screen may be also disposed on the rear case 102.

The touch pad 135 may be operated in conjunction with the display unit 151 of the front case 101. The touch pad 135 may be disposed in parallel at a rear side of the display unit 151. The touch pad 135 may have the same size as or a smaller size than the display unit 151.

Hereinafter, embodiments associated with a mobile terminal having the foregoing configuration will be described with reference to the accompanying drawings. The following embodiments may be used in a single or combined manner. Furthermore, the following embodiments may be also used in combination with the foregoing user interface (UI).

The embodiments disclosed herein may be implemented in the mobile terminal 100 described with reference to FIGS. 1 through 2B.

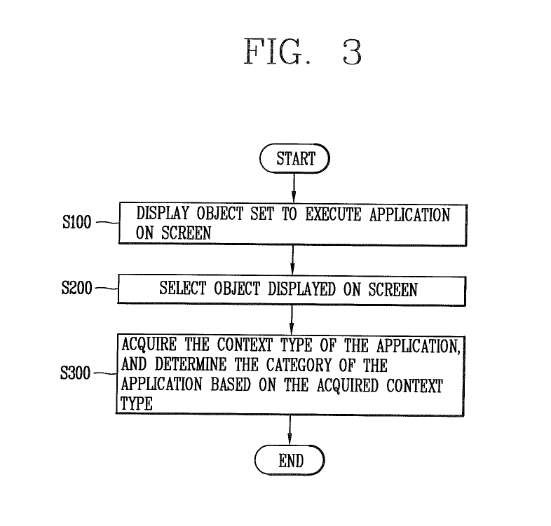

Hereinafter, referring to FIGS. 3 through 7B, a method of grouping applications in the mobile terminal 100 according to the embodiments of the present invention and the operation of the mobile terminal 100 for implementing the foregoing method will be described in detail.

The mobile terminal 100 disclosed herein may be controlled to install and execute an application downloaded from an external network as well as various user interfaces. Furthermore, the mobile terminal 100 may control the display unit 151 to display an image associated with the application being executed by a user's selection.

The term object (or item) used in the following description may denote a menu or icon set to execute the corresponding application. Furthermore, the term group object (or group item) may denote a folder or directory configured and maintained to include at least one object and/or at least one group object.

The term context type used in the following description may denote a kind of data or module accessed by an application when executing the application. For example, the context type may include a kind of state information of the mobile terminal 100 such as time information, location information, inclination information, and the like, or a kind of data logically classified in the memory 160 such as contacts, messages, weather data, and the like. Furthermore, the context type may denote a kind of module used in the process of executing an application such as a mobile communication module 112, a wireless Internet module 113, a near field communication module 114, and the like.

FIG. 3 is a flow chart illustrating the process of grouping applications in a mobile terminal according to an embodiment of the present invention.

The controller 180 may control the wireless communication unit 110 or interface unit 170 to acquire an application from an application providing server. Furthermore, the controller 180 may store and install the acquired application in the memory 160.

If the application is installed, then the memory 160 may store the application program and data, and the controller 180 may manage the installation information of the application. Furthermore, if the application is installed, then the controller 180 may generate an object set to execute the installed application, and store the generated object in the memory 160.

Upon receiving a request for displaying an idle screen, the controller 180 may display an idle screen including at least one object stored in the memory 160 through the display unit 151 (S100). An object displayed on the idle screen may be selected through the user input unit 130, and when the object is selected, an application corresponding to the selected object may be executed.

The controller 180 may select at least one of the objects displayed on the screen (S200). In an embodiment, the controller 180 may select an object set to call an application being installed and executed when the application is installed and executed.

In another embodiment, in a state that at least one object is displayed on the idle screen through the display unit 151, an object set to call a function of grouping applications may be selected through the user input unit 130. If the object set to call a function of grouping applications is selected, then a user interface capable of selecting at least one object being displayed on the screen may be provided.

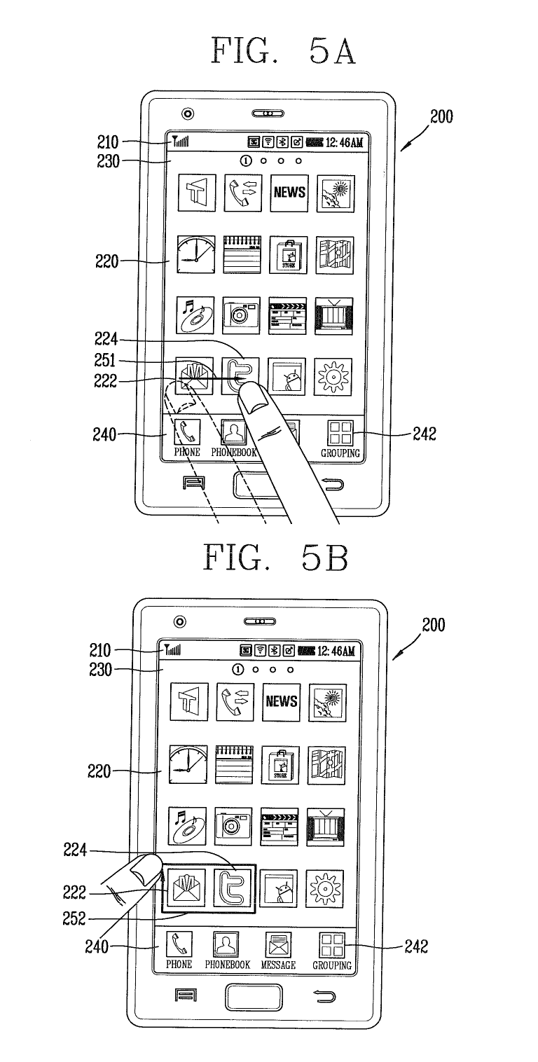

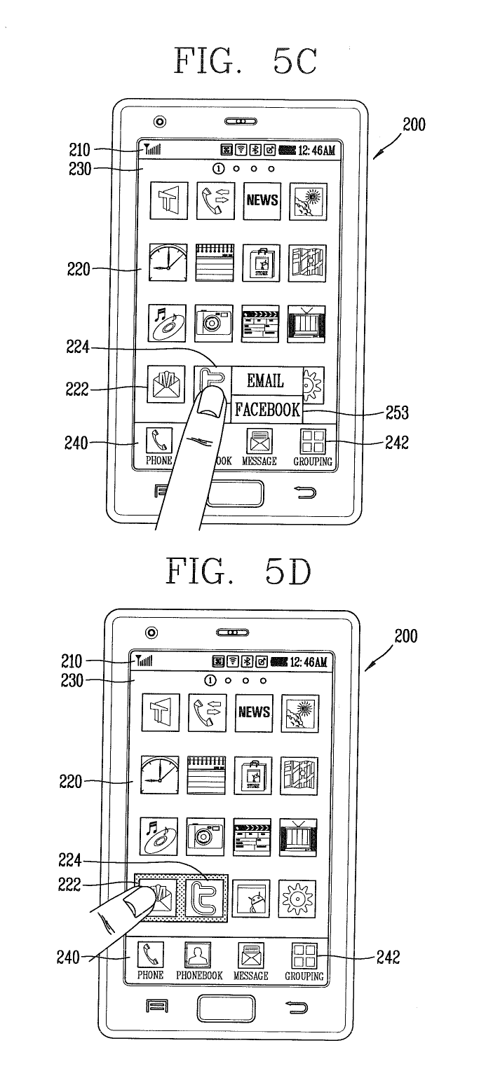

Upon receiving an input for selecting at least one object displayed on an idle screen through the user input unit 130, the controller 180 can select at least one object based on the received input. In this case, a plurality of objects may be selected, and information on an application related to the similar context type or an object corresponding to the application may be provided, and the embodiments thereof will be described in detail with reference to FIGS. 5A through 5D.

For example, if an object displayed on the idle screen is selected, then the controller 180 may control the display unit 151 to display a context type of the application corresponding to the selected object. Furthermore, if an object displayed on the idle screen is selected, then the controller 180 may control the display unit 151 to display at least one object related to a context type of the application corresponding to the selected object.

If at least one object displayed on the idle screen is selected, then the controller 180 may acquire a context type of the application corresponding to each of the selected at least one object. For example, the controller 180 may acquire a context type based on information (identification information of an intent or provider, or information detected from a script) referred to when the application corresponding to the selected object accesses data stored in the memory 160.

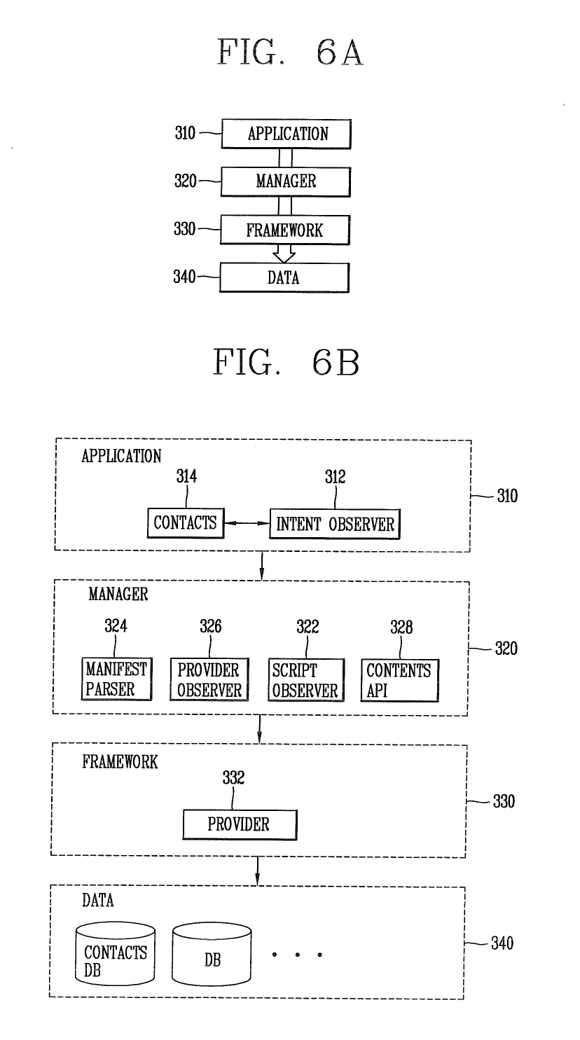

When the controller 180 has failed to acquire a context type, then the controller 180 may acquire a context type from an application providing server, or receive an input for selecting a context type through the user input unit 130, thereby acquiring a context type of the application. The embodiments thereof will be described in detail with reference to FIGS. 6A and 6B.

Furthermore, the controller 180 may determine the category of each application corresponding to the selected at least one object based on the acquired context type (S300). In an embodiment, the controller 180 may determine the name of the context type as a category of the object. In this case, the category may be time, contacts, 3G, and the like.

In another embodiment, when there exist a plurality of context types acquired from one application, the names of the plurality of context types may be combined to determine the combined name as a category of the object. In this case, the category may be time and contacts, contacts and 3G, time and 3G, time, contacts and 3G, and the like.

In still another embodiment, when there exist a plurality of context types acquired from one application, the name of the context type having the highest priority may be determined as a category of the object among the plurality of context types. The criteria for determining the priority may be an acquisition frequency of the context type, an access time for data or module related the context type, and the like.

The controller 180 can move the selected object to a group object corresponding to the determined category. Furthermore, the controller 180 may generate a group object corresponding to the determined category, and move the selected object to the generated group object.

Accordingly, a group object instead of an object may be displayed on the idle screen, and if a group object is selected, then an object included in the group object may be displayed on the idle screen. For example, the controller 180 can move the selected at least one object to folders indicated for each category, respectively, based on the determined category.

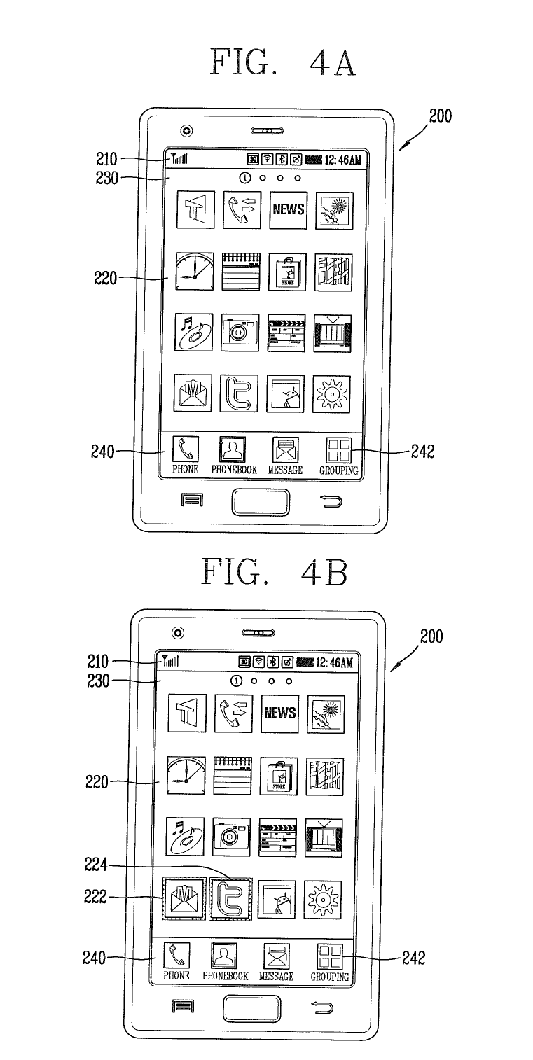

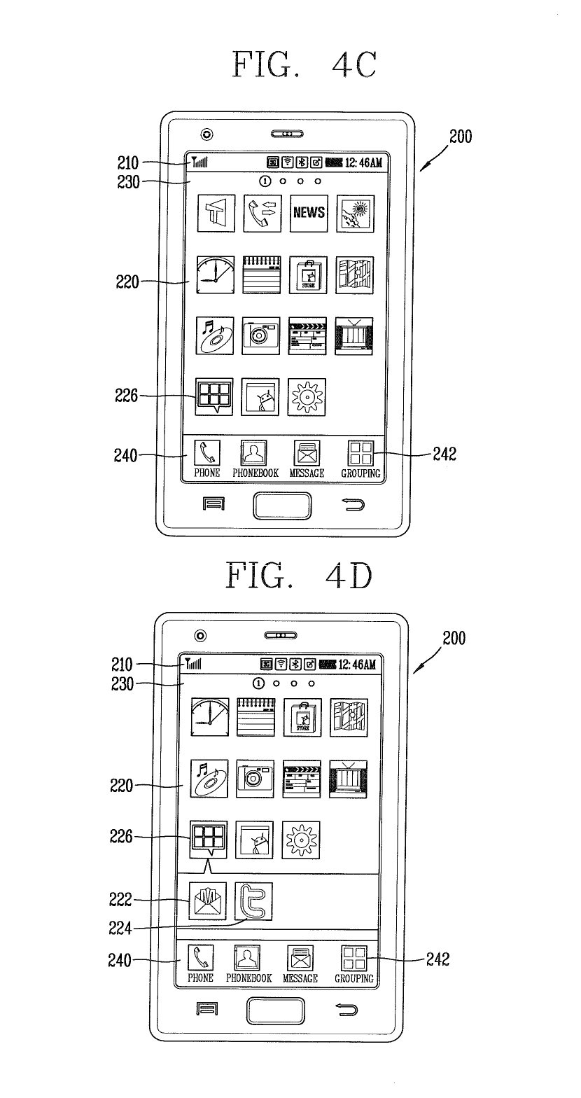

FIGS. 4A through 4D are conceptual views illustrating the process of grouping applications according to an embodiment of the present invention.

Referring to FIG. 4A, a status display area 210 indicating the status information of the mobile terminal 100, a first object display area 220 indicating objects in which each object is set to call an application, a page display area 230 indicating page information, and a second object display area 240 indicating objects in which each object is set to call an application are displayed on idle screen 200.

The status display area 210 may display an indicator indicating a communication status of the mobile terminal, an indicator indicating a current time, an indicator indicating a remaining amount of battery, and the like.

The first object display area 220 may display at least one object set to call each application. The first object display area 220 may further display a name of the application adjacent to the object.

The page display area 230 may visually display a relation between each page including at least one object displayed on the first object display area 220. For example, the number of total pages and the location of a current page may be visually displayed on the page display area 230.

The second object display area 240 may display at least one object set to call each application. The second object display area 240 may further display the names of the application adjacent to the objects, respectively.

On the other hand, objects displayed on the first object display area 220 may be dynamically changed depending on a page change input whereas objects displayed on the second object display area 240 may be statically displayed. Accordingly, the user may set to display a plurality of objects to be divided into pages on the first object display area 220, but on the contrary may set to statically display frequently used objects on the second object display area 240.

If any one of objects displayed on the first object display area 220 or objects displayed on the second object display area 240 is selected, then an application corresponding to the selected object can be executed. In addition, the location of the selected object may be changed or the object may be deleted based on the user's input.

Referring to FIG. 4A, an object 242 set to call an application grouping function may be displayed on the second object display area 240. The object 242 may be displayed on the second object display area 240, but may be also displayed on the first object display area 220. Alternatively, a function key instead of the object 242 may be provided in the mobile terminal 100 to call an application grouping function when the function key is selected. The user input unit 130 may receive an input for selecting the object 242 or function key, and then call an application classification function upon receiving the input.

Referring to FIG. 4B, if the object 242 is selected, then the controller 180 may provide a user interface capable of selecting at least one object displayed on the first object display area 220. The user input unit 130 may receive an input for selecting at least one of objects displayed on the first object display area 220.

Referring to FIG. 4B, if a first object 222 and a second object 224 are selected, then the selected objects 222, 224 can be displayed to be distinguished from the other objects which are not selected on the first object display area 220. In a state that the objects 222, 224 are selected, the controller 180 can monitor whether or not an input for selecting the object 242 or function key is received.

If the user input unit 130 senses an input for selecting the object 242 or function key, then the controller 180 may acquire a context type for an application corresponding to each selected object. Furthermore, the controller 180 may determine the category of each selected object based on the acquired context type.

In FIG. 4B, if the category of each selected object is determined, then the controller 180 may group objects based on the determined category. Each object may be moved to a group object corresponding to each determined category.

When there exists a group object corresponding to the determined category for an object, the object is moved to the group object. On the contrary, when there exists no group object corresponding to the determined category for an object, a group object corresponding to the determined category is generated and the object is moved to the generated group object.

Referring to FIG. 4C, a category for the selected objects 222, 224 in FIG. 4B may be determined as a message. The controller 180 may determine whether there exists any group object corresponding to the message category. Furthermore, when exists no group object corresponding to the message category, a group object 226 corresponding to the message category may be generated. Furthermore, the controller 180 may move the selected objects 222, 224 to the generated group object 226. As a result, the group object 226 may be displayed on the screen 200 of the mobile terminal 100.

If the group object 226 is selected as illustrated in FIG. 4C, then information on objects included in the group object 226 may be displayed on the screen 200. In other words, referring to FIG. 4D, if the group object 226 is selected, then the objects 222, 224 included in the group object 226 may be displayed on the screen 200. If either one of the objects 222, 224 is selected in a state that the objects 222, 224 are displayed on the screen 200, then an application corresponding to the selected objects 222, 224 may be executed.

FIGS. 5A through 5D are conceptual views for explaining the process of selecting an object illustrated in FIG. 3.

If an object 242 set to call an application classification function is selected, then a user interface capable of selecting at least one object may be provided. The user input unit 130 may sense a touch input, and the controller 180 may select at least one object based on the sensed touch input. For example, as a plurality of touch inputs are sensed in a state that a user interface capable of selecting at least one object is provided, the controller 180 may select each object corresponding to the sensed touch inputs.

Referring to FIG. 5A, the user input unit 130 may receive a touch input for selecting a plurality of objects. The controller 180 may select at least one object 222, 224 being brought into contact with an open curve 251 configured by a touch input among part or all of the objects displayed on the screen 200.

Referring to FIG. 5B, the user input unit 130 may receive a touch input for selecting a plurality of objects. The controller 180 may select at least one object 222, 224 being brought into contact with or included in a close curve 252 configured by a touch input among part or all of the objects displayed on the screen 200.

Referring to FIG. 5C, the user input unit 130 may receive a touch input for selecting an object. In this case, the controller 180 may acquire the context type of an application corresponding to the selected object, and the display unit 151 may display information 253 on an object corresponding to each of at least one application that use the same context type as the acquired context type on the screen 200.

Referring to FIG. 5D, the user input unit 130 may receive a touch input for selecting an object. In this case, the controller 180 may acquire the context type of an application corresponding to the selected object. Furthermore, the display unit 151 may display objects 222, 224 corresponding to each of at least one application that use the same context type as the acquired context type to be distinguished from the other objects on the screen 200. In this case, the controller 180 may automatically select objects 222, 224 corresponding to each of at least one application that use the same context type as the acquired context type.

FIGS. 6A and 6B are views for explaining the process of acquiring a context type illustrated in FIG. 3.

FIG. 6A illustrates a schematic conceptual view for explaining a method of acquiring a context type of the application according to an embodiment of the present invention.

An application 310 may include various applications such as emails, clients, SMS, maps, browsers, contacts, and the like. The manager 320 may manage and observe an operation required to access data, data, or the like, on the application 310 to perform the role of transferring it to a framework 330. The framework 330 may check an operation, data, or the like, transferred from the manager 320, and accordingly set an address, an authority, or the like, required to access data, thereby allowing the application 310 to access data 340. On the other hand, an address, an authority, or the like, required for the application 310 to access data, may be directly transferred to the framework 330. The data 340 may denote data stored in the memory 160 such as a system setting value or media content.

According to an embodiment of the present invention, the controller 180 may acquire a context type of the application based on an operation, a script, an application protocol interface (API), address information, or the like, referred to when the application is installed or executed. For example, when an application is installed or executed on the application 310, the application can access data 340 managed by the corresponding application or other applications through the framework 330. The manager 320 for managing or observing the process may acquire a context type of the application based on various information required to access the data 340.

FIG. 6B illustrates a detailed conceptual view for explaining a method of acquiring a context type of the application according to an embodiment of the present invention.

Referring to FIG. 6B, in an embodiment, when an application 314 included in the application 310 attempts to access a specific database, the application 314 may generates an intent related to the specific database to transmit it to the framework 330. In this case, an intent observer 312 may observe an intent related to the specific database, and determine a context type of the application 314 according to an instruction of the script observer 322 of the manager 320 based on the intent.

For example, the context type of a multimedia message service (MMS) application may be confirmed as “message” from the process of generating an intent such as “Intent mmsIntent=new Intent(Intent.ACTION_SEND); mmsIntent.setClassName(“com.android.mms”, “com.android.mms.ui.ComposeMes sageActivity”);”.

In another embodiment, when the application 314 included in the application 310 attempts to access a specific database, the application 314 can access the specific database through a system setting value or a provider 332 that can access media contents. In this case, a provider observer 326 may determine a context type of the application 314 according to an instruction of the script observer 322 of the manager 320 based on provider information managed by the specific database and the application 310.

For example, the provider being accessed when a contacts application accesses a contacts database has a type such as “com.android.providers.contacts”, and here the context type of the contacts application may be confirmed as “contacts”.

In still another embodiment, if the application 314 included in the application 310 is installed, then the system can configure information on the application and maintain prior to executing the application. In this case, a manifest parser 324 may examine information on the application to check information related to the application, and determine a context type of the application 314 according to an instruction of the indicator 322 of the manager 320.

For example, the intent filter and authority for a contacts application have a type such as “<uses-permission android:name=“android.permission.READ_CONTACTS/>”, and here the context type of the contacts application may be confirmed as “contacts”.

In still another embodiment, contents API 328 may check a context type of applications from an application protocol interface (API) set of applications classified according to the category.

On the other hand, when the controller 180 has failed to acquire a context type, the user input unit 130 may receive a context type of the application corresponding to each of the selected at least one object. Alternatively, when the controller 180 has failed to acquire a context type, the wireless communication unit 110 may acquire each category information of the selected at least one object from an application providing server. In this case, the controller 180 may determine each category of the selected at least one object based on the category information acquired from the application providing server.

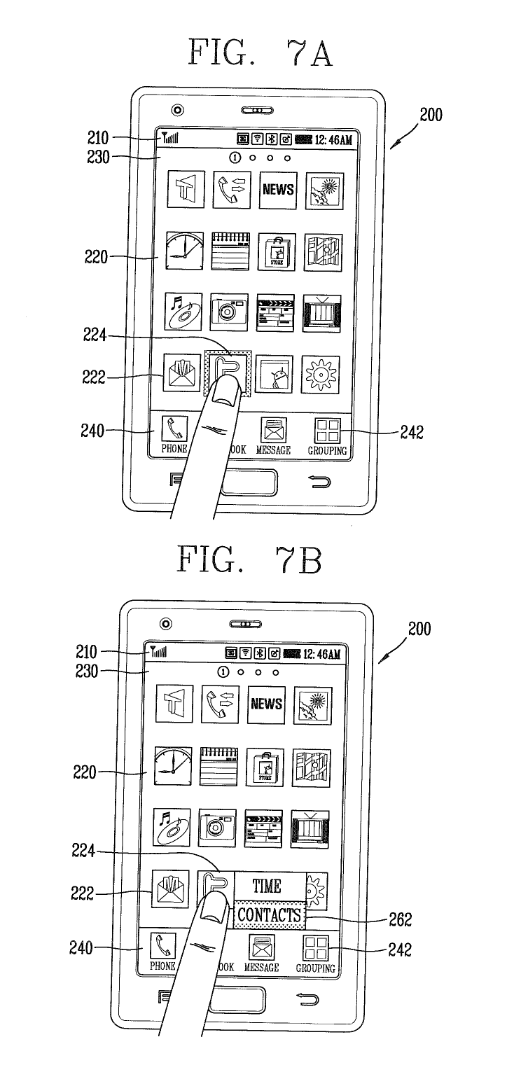

FIGS. 7A and 7B are conceptual views illustrating the process of manually grouping applications according to an embodiment of the present invention.

If an object 242 set to call an application classification function is selected, then a user interface capable of selecting at least one object may be provided. The user input unit 130 may sense a touch input, and the controller 180 may select at least one object based on the sensed touch input. Alternatively, the user input unit 130 may receive an input for selecting a context type of the application corresponding to the selected object. The controller 180 may acquire a context type of the corresponding object based on an input for selecting the context type.

Referring to FIG. 7A, the user input unit 130 may receive a touch input for selecting one object 224. The controller 180 may select the object 224 based on the touch input. In a state that the object 224 is selected, the user input unit 130 may receive an input for displaying selectable context types of the selected object 224. For example, it may be possible to receive a long press input for the object 224 or select a menu for displaying selectable context types.

Referring to FIG. 7B, if the user input unit 130 receives an input displaying selectable context types, then the controller 180 may check a selectable context types list 262 from the memory 160 to display the selectable context types list 262 on the screen 200. Furthermore, the controller 180 may acquire a context type of the application corresponding to the selected object 224, and display the acquired context type to be distinguished from the other context types within the selectable context types list 262.

If a context type is selected, then the controller 180 may determine a category according to the selected context type, and group objects according to the determined category. Accordingly, an object can be moved to a group object corresponding to the selected category.

According to an embodiment of the present invention, a user may conveniently perform a function of grouping various applications that can be executed in a mobile terminal. In particular, according to an embodiment, a context type referred to application classification can be acquired by using information detected when an application is installed or executed in a mobile terminal and thus the function of grouping applications can be automatically implemented, thereby having the advantage of providing convenience to a user.

In addition, the user may perform a function of selectively grouping applications desired to be classified, thereby more effectively managing the applications. In particular, there exists an advantage that the function of selecting applications required for a grouping function can be intuitively carried out in a touch sensor based mobile terminal.

According to an embodiment of the present invention, the foregoing method may be implemented as codes readable by a processor on a medium written by the program. Examples of the computer-readable media may include ROM, RAM, CD-ROM, magnetic tape, floppy disk, and optical data storage device, and the like, and also include a device implemented in the form of a carrier wave (for example, transmission via the Internet). According to a mobile terminal and an operation control method thereof as described above, the configurations and methods of the above-described embodiments will not be applicable in a limited way, and all or part of each embodiment may be selectively combined and configured to make various modifications thereto.

Here, the terms and words used herein and the claims should not be construed by limiting to their typical or lexical meaning, but should be construed based on the meaning and notion conforming to the technical concept of the present invention. Accordingly, the configuration illustrated in the embodiments disclosed herein and the drawings is merely the most preferred embodiment of the present invention, and is not intended to represent all the technical concept of the present invention, and thereby it should be appreciated that there may exist various equivalents and modifications for substituting those at the time of filing this application.

What is claimed is:

1. A mobile terminal, comprising:
a storage unit configured to store an application and an object set to execute the application;
a display unit configured to display the object on a screen; and
a controller configured to acquire a context type of the application when the object displayed on the screen is selected, and determine a category of the application based on the acquired context type.

2. The mobile terminal of claim 1, wherein the controller selects the object displayed on the screen when the application is installed or executed.

3. The mobile terminal of claim 1, further comprising:
an input unit configured to sense an input for selecting the object displayed on the screen.

4. The mobile terminal of claim 1, wherein the controller controls the display unit to display a context type of the application on the screen when the object displayed on the screen is selected.

5. The mobile terminal of claim 1, wherein the controller controls the display unit to display at least one object related to a context type of the application on the screen when the object displayed on the screen is selected.

6. The mobile terminal of claim 1, wherein the controller acquires the context type based on information referred to when the application accesses data stored in the storage unit.

7. The mobile terminal of claim 6, wherein the information comprises the identification information of an intent or provider generated when executing the application.

8. The mobile terminal of claim 6, wherein the information is detected from a script generated when installing the application.

9. The mobile terminal of claim 1, wherein the controller acquires the context type from an application providing server.

10. The mobile terminal of claim 1, further comprising:
an input unit configured to sense an input for selecting the context type.

11. The mobile terminal of claim 1, wherein the controller moves the object to a group object corresponding to the determined category.

12. The mobile terminal of claim 1, wherein the controller generates a group object corresponding to the determined category, and moves the object to the generated group object.

13. The mobile terminal of claim 1, wherein the context type comprises data accessed or a module type used while executing the application.

14. The mobile terminal of claim 1, wherein the category is a name of the context type.

15. A method of grouping applications in a mobile terminal, the method comprising:
displaying an object set to execute an application on a screen;
selecting an object displayed on the screen; and
acquiring a context type of the application, and determining a category of the application based on the acquired context type.

16. The method of claim 15, wherein said selecting step further comprises sensing an input for selecting the object displayed on the screen.

17. The method of claim 15, wherein said selecting step comprises displaying at least one object related to a context type of the application on the screen when the object displayed on the screen is selected.

18. The method of claim 15, further comprising:
moving the object to a group object corresponding to the determined category.

19. The method of claim 15, further comprising:
generating a group object corresponding to the determined category; and
moving the object to the generated group object.

20. The method of claim 15, wherein the category is a name of the context type.
